(19) United States
(12) Patent Application Publication
(10) Pub. No.: US 2007/0285848 A1
(43) Pub. Date: Dec. 13, 2007

(54) Magnetoresistance device

(76) Inventors: David Williams, Cambridgeshire (GB); Jorg Wunderlich, Cambridgeshire (GB); Andrew Troup, Cambridgeshire (GB); David Hasko, Cambridgeshire (GB)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/606,183

(22) Filed: Nov. 30, 2006

(30) Foreign Application Priority Data
Jun. 13, 2006 (EP) 061165403.5

(51) Int. Cl. G11B 5/127

(52) U.S. Cl. 360/324.1

(57) ABSTRACT

A magnetoresistance device includes an elongate channel formed of silicon. A conductor comprising titanium silicide is connected to the channel along one side of the channel and leads are connected to and spaced along the channel on the opposite side.

### FIELD OF THE INVENTION

The present invention relates to a magnetoresistance device particularly, but not exclusively, for use as a magnetic field sensor or a read head in a hard disk drive.

### BACKGROUND ART

Hard disk drives (HDDs) are widely used for high-density information storage. HDDs are commonly found in computer systems traditionally associated with this type of storage, such as servers and desktop computers. However, HDDs having smaller form factors, such as 1-inch drives, can also be found in hand-held electronic devices, such as music players and digital cameras.

Higher storage capacity in HDDs can be achieved by increasing storage density. Storage density is currently doubling toughly every year and the highest storage density presently achievable using conventional technology, such as by recording data in bit cells which are arranged longitudinally in the magnetic recording medium and reading data using so-called “spin value” read heads, is about 100 Gb/in².

However, as storage density in HDDs continues to increase, then recording media and read heads encounter the problem of the superparamagnetic effect.

The superparamagnetic effect arises when the size of a ferromagnetic grain is sufficiently reduced that the energy required to change direction of magnetisation of the grain is comparable to the thermal energy. Thus, the magnetisation of the grain is liable to fluctuate and so lead to data corruption.

For recording media, a solution to the problem has been demonstrated which involves arranging bit cells perpendicularly (rather than longitudinally) to the surface of the recording medium which allows each bit cell to be large enough to avoid the superparamagnetic effect.

To address this problem in read heads, it been proposed to avoid using any ferromagnetic material and to take advantage of the so-called extraordinary magnetoresistance (EMR) effect.

A device exhibiting the EMR effect is described in “Enhanced Room-Temperature Geometric Magnetoresistance in Inhomogeneous Narrow-Gap Semiconductors”, by S. A. Solin, T. Thio, D. R. Hines and J. J. Heremans, Science volume 289, p. 1530 (2000). The device is arranged in a van der Pauw configuration and includes a highly conductive gold inhomogeneity concentrically embedded in a disk of non-magnetic indium antimonide (InSb). At zero applied magnetic field (H=0), current flows through the gold inhomogeneity. However, at non-zero applied magnetic field (H≠0), current is deflected perpendicularly to the field-line distribution, around the gold inhomogeneity and through the annulus. This gives rise to a drop in conductance.

However, this device suffers several drawbacks and so is ill suited to being used as read head. For example, the device has a configuration which is not suited to being scaled down to smaller dimensions, is heavily depleted and exhibits strong boundary and interface scattering. Furthermore, indium antimonide is an expensive material and has poor mechanical properties, which makes it difficult to process and to provide a reliable, long-lasting sensor.

Currently, high mobility narrow gap semiconductors with low carrier density, such as indium antimonide (μₙ=7×10⁴ cm²V⁻¹s⁻¹ at 300°K), indium arsenide (μₙ=3×10⁴ cm²V⁻¹s⁻¹ at 300° K) and gallium arsenide (μₙ=8.5×10³ cm²V⁻¹s⁻¹ at 300° K), seem to be the best candidates for EMR-based read heads. However, these materials also tend to be expensive material and have poor mechanical properties.

The present invention seeks to provide an improved magnetoresistance device.

### BRIEF SUMMARY OF THE INVENTION

According to a first aspect of the present invention there is provided a magnetoresistance device comprising a channel comprising non-ferromagnetic semiconducting material, the channel extending from a first end to a second end, a conductor comprising non-ferromagnetic material having a higher conductivity than the semiconducting material and connecting at least two sections of the channel and a plurality of leads connected to and spaced apart along the channel.

This device configuration is better suited to be scaled to smaller dimensions, e.g. down to channel widths less than 100 nm, while still being able to contact the channel with leads.

The channel may comprise silicon. Thus, the device can exhibit the extraordinary magnetoresistance effect even though the mobility of silicon is comparatively low (μₙ=1.5×10³ cm²V⁻¹s⁻¹ at 300° K) compared with, for example, indium antimonide. However, using silicon has the advantage that standard silicon processing techniques can be used. Furthermore, the device is likely to be more robust, chemically, thermally and mechanically.

The channel may comprise silicon germanium. Silicon germanium can exhibit a higher mobility than silicon and so can lead to a higher magnetoresistance.

The channel may be an elongate channel. The channel may be curved. The semiconducting material may be doped with an impurity having a concentration up to 1×10¹⁷ cm⁻³, up to 1×10¹⁸ cm⁻³ or up to 1×10¹⁹ cm⁻³. The semiconductor material may be undoped. The channel may be provided in a layer having a thickness less than 50 nm.

The conductor may be arranged laterally to the channel. The conductor may extend along the channel. The conductor may extend from the first end to the second end of the channel. The device may include an interface between the conductor and channel, the interface being broken into at least two, separate sections.

The conductor may comprise semiconducting material. The semiconducting material comprising the conductor may be doped with an impurity having a concentration of at least 1×10¹⁹ cm⁻³.

The conductor may comprise silicon and, thus, the device can benefit from advantages listed earlier.

The conductor may comprise a metal silicide, such as titanium silicide. Using titanium silicide can have several advantages. For example, the resistivity of titanium silicide is usually 14-16 μΩcm for the C54 phase at 300° K, which compares well to the resistivities of some of the best conductors, such as gold which has a conductivity of 2.2 μΩcm. Also, if the channel is formed of silicon, then an interface between titanium silicide and silicon has a low contact resistance. Furthermore, titanium silicide can be formed by means of diffusing silicon into titanium and so can be easily formed. In addition, titanium silicide tends to exhibit good resistance to electromigration.

The conductor may comprise a non-ferromagnetic metal or alloy, such as aluminium.

The conductor may be provided in a layer having a thickness less than 50 nm.

The leads may extend laterally from the channel. The conductor may be connected to the channel along a first side of the channel. At least some of the leads may be connected to the channel on a second, opposite side of the channel. At least some of the leads may be connected to the channel on an upper or lower surface of the channel.

The device may comprise first, second, third and fourth leads arranged in order along channel. The first and second leads may be spaced apart by a first separation, the second and third leads may be spaced apart by a second separation less than the first separation and the third and fourth leads may be spaced apart by third separation less than the first separation.

The leads may comprise semiconducting material. The leads may comprise the semiconducting material comprising the channel. The leads and the channel may be unitary. The leads may comprise silicon. The leads may comprise a metal silicide, such as titanium silicide. The leads may comprise a non-ferromagnetic metal or alloy. The leads may each have a thickness less than 50 nm.

The channel may have a width less than 100 nm and/or a length less than 10 μm. The conductor may have a width up to 500 nm and/or a length less than 10 μm. The leads may each have a width up to 200 nm, the width being in a direction which corresponds to length for the channel.

The device may further comprise a base comprising insulating material, wherein the channel, conductor and leads lie on the base. The device may further comprise a substrate, the base being disposed on the substrate. The device may further comprise contact regions arranged in the substrate between the leads and include channels between the contact regions under the leads so as to provide field effect transistors. Thus, gain-producing capability can easily be integrated into the device.

The device may further comprise a cap comprising insulating material, wherein the cap lies over the channel, region and leads. For example, a thin (e.g. 2 nm) cap of silicon dioxide can be used, which helps to protect the device while also allowing it to be placed close to a magnetic field source, such as a hard disk platen.

The device may further comprise circuitry for controlling the device. The circuitry may be configured to drive current between non-adjacent leads and to measure a voltage developed between a lead between the non-adjacent leads and another lead.

According to a second aspect of the present invention there is provided a read head for a hard disk drive comprising the magnetoresistance device.

According to a third aspect of the present invention there is provided a hard disk drive including at least one read head.

According to a fourth aspect of the present invention there is provided a method of fabricating a magnetoresistance device, the method comprising forming a channel comprising semiconducting material, the channel extending between first and second ends, and connecting at least two sections of the channel using a conductor comprising non-ferromagnetic material having a higher conductivity than the semiconducting material and connecting to the channel a plurality of leads spaced apart along the channel.

The semiconducting material may be silicon and the method may comprise providing a layer of silicon, patterning said layer so as to define a patterned layer having a first region corresponding to the conductor, a second region corresponding to the channel and further regions corresponding to the leads, providing a metal, for example titanium, over the first region and annealing so as to form a metal silicide, for example titanium silicide, in said first region.

According to a fifth aspect of the present invention there is provided method of operating a magnetoresistance device comprising a channel comprising non-ferromagnetic semiconducting material, the channel extending from a first end to a second end, a conductor comprising non-ferromagnetic material having a higher conductivity than the semiconducting material and connecting at least two sections of the channel and a plurality of leads connected to and spaced apart along the channel, the method comprising driving current between non-adjacent leads and measuring a voltage developed between a lead between the non-adjacent leads and another lead.

Driving the current between non-adjacent leads may comprise driving a current having a magnitude of at least 1 μA. The method may comprise applying a magnetic field to the device.

### DETAILED DESCRIPTION OF THE DRAWINGS

Embodiments of the present invention will now be described, by way of example, with reference to the accompanying drawings in which:

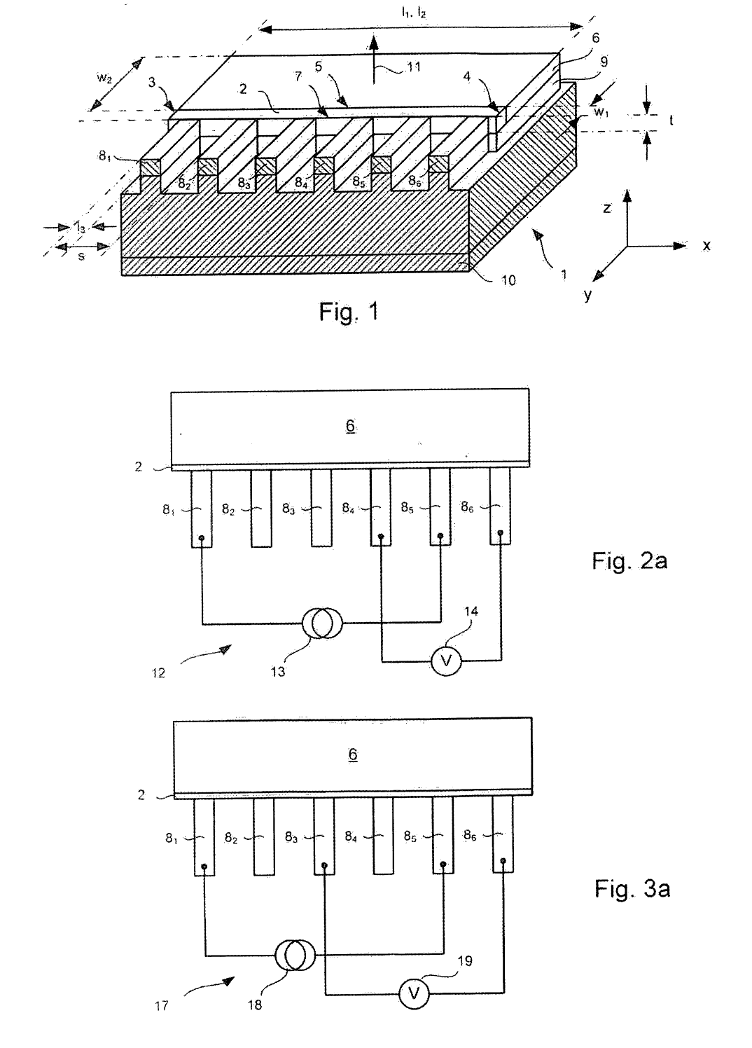

FIG. 1 is a perspective view of a magnetoresistance device according to certain embodiments of the present invention;

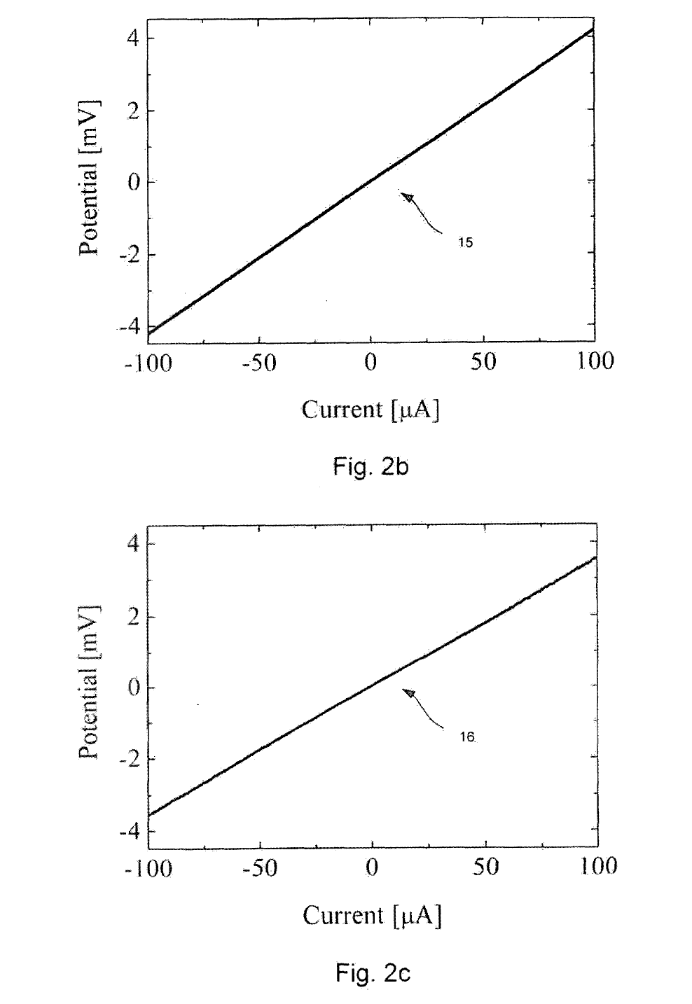

FIG. 2a is a schematic view of a first circuit configuration for measuring the device shown in FIG. 1;

FIG. 2b illustrates a theoretical current-voltage characteristic for the circuit configuration shown in FIG. 2a;

FIG. 2c illustrates a measured current-voltage characteristic at 300° K obtained using the circuit configuration shown in FIG. 2a;

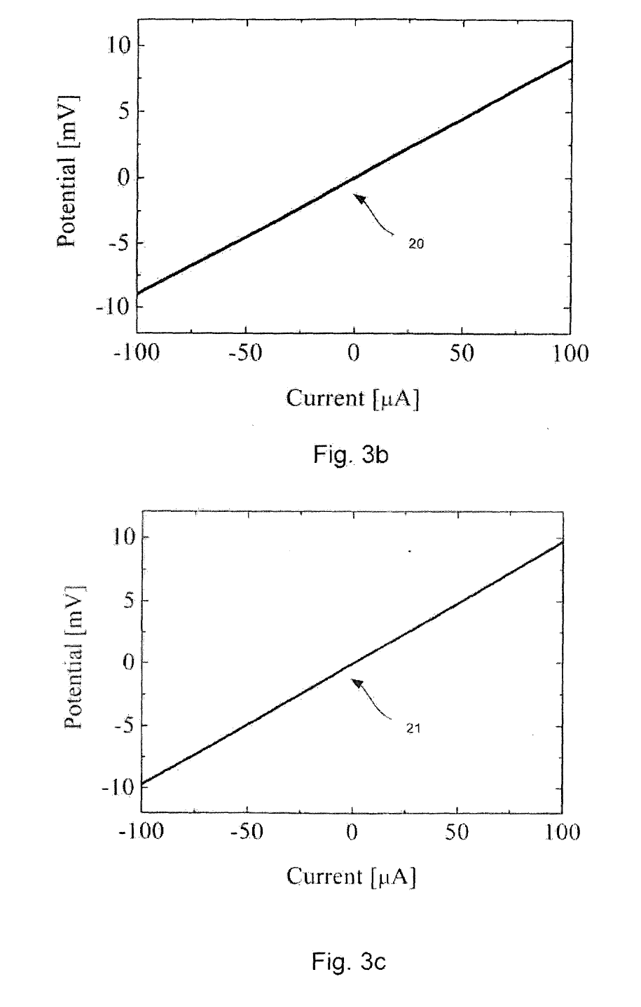

FIG. 3a is a schematic view of a second circuit configuration for measuring the device shown in FIG. 1;

FIG. 3b illustrates a theoretical current-voltage characteristic for the circuit configuration shown in FIG. 3a;

FIG. 3c illustrates a measured current-voltage characteristic at 300° K obtained using the circuit configuration shown in FIG. 3a;

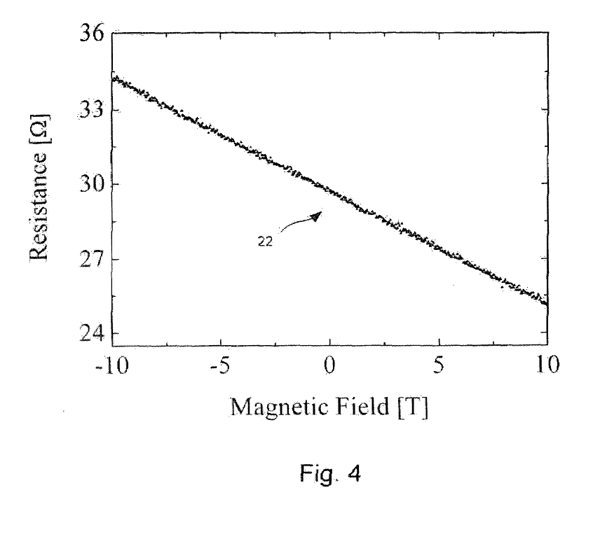

FIG. 4 is a graph of resistance against applied magnetic field;

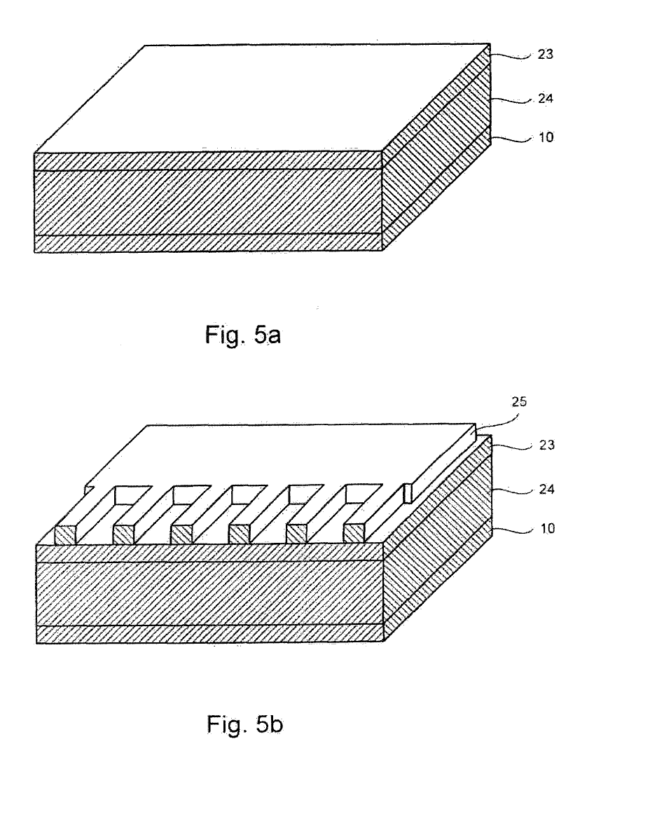

FIGS. 5a to 5d are perspective views of the device of FIG. 1 at different stages during its fabrication;

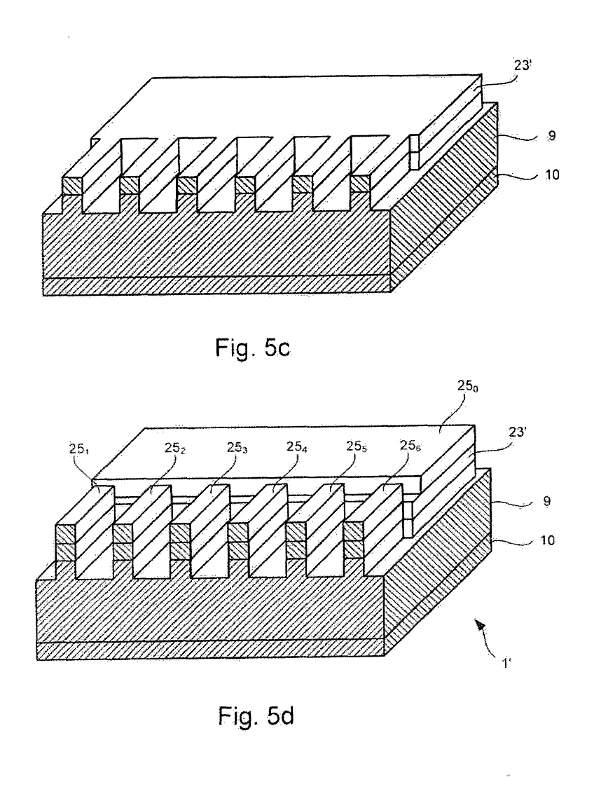

FIGS. 6a to 6c are micrographs of the device of FIG. 1 at different stages during its fabrication;

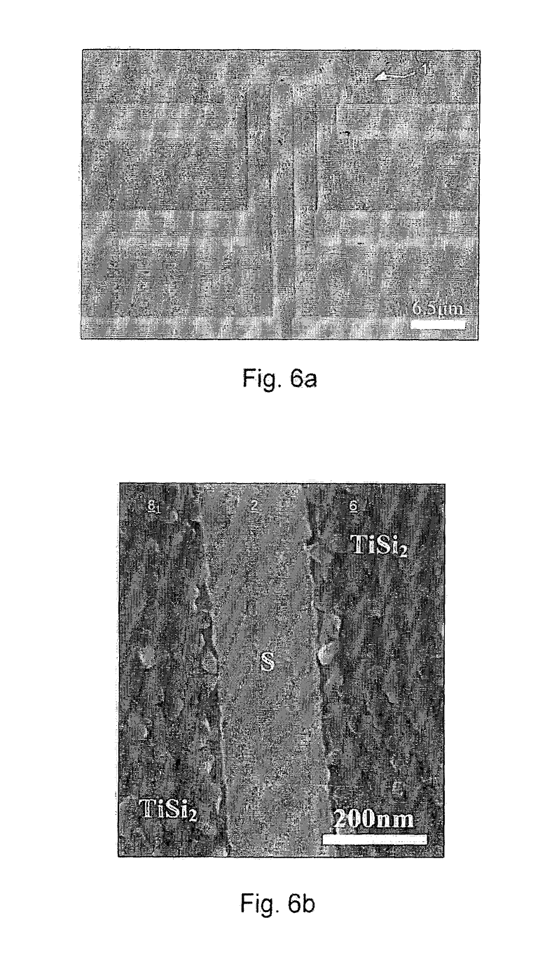

FIG. 7a is a plan view of another magnetoresistance device according to the present certain embodiments of invention;

FIG. 7b is a cross sectional view of the embodiment shown in FIG. 7a, taken along the line A-A′;

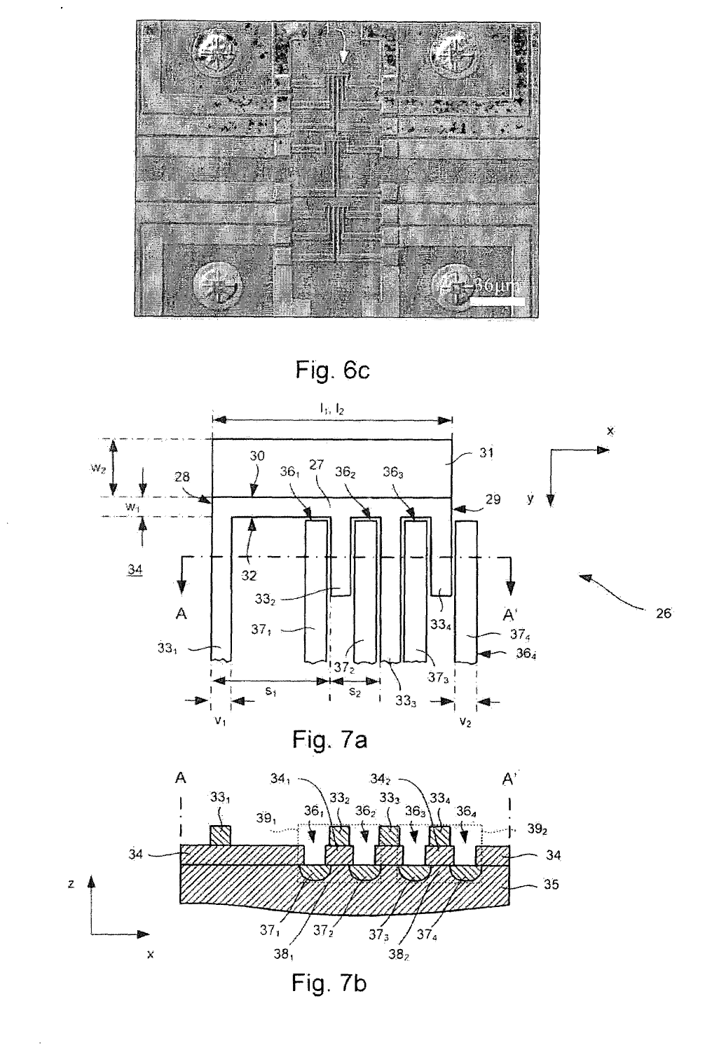

FIG. 8 is a schematic view a hard disk drive including a magnetoresistance device in accordance with certain embodiments of the present invention; and

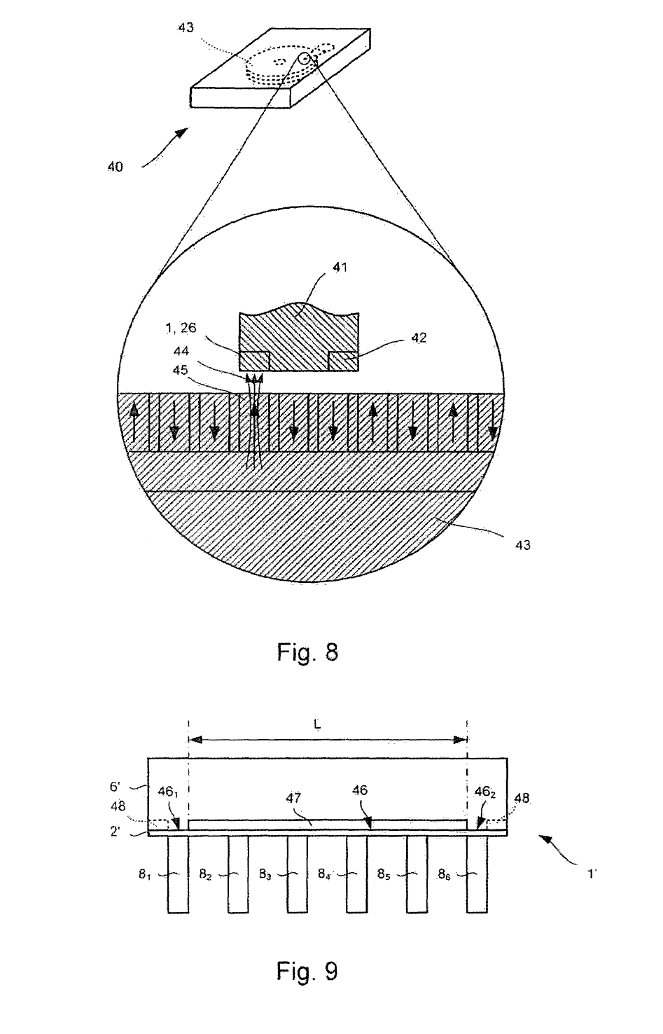

FIG. 9 illustrates a modification to the device shown in FIG. 1.

### DETAILED DESCRIPTION OF EMBODIMENTS

Referring to FIG. 1, a first magnetoresistance device 1 according to certain embodiments of the present invention is shown. The device 1 includes a channel 2 formed of n-type polycrystalline silicon (Si) doped with phosphorous (P) to a concentration of 6.4×10¹⁹ cm⁻³ and having a thickness, t, of 37 nm. The channel 2 extends between first and second ends 3, 4 and has connected thereto, along a first side 5, a conductor or region 6 formed of titanium silicide (TiSi₂) having a thickness of about 40 nm and, on a second, opposite side 7, first, second, third, fourth, fifth and sixth leads 8₁, 8₂, 8₃, 8₄, 8₅, 8₆ also formed of titanium silicide and spaced apart along the channel 2. The first, second, third, fourth, fifth and sixth leads 8₁, 8₂, 8₃, 8₄, 8₅, 8₆ are arranged in order along the channel 2 with the first lead 8₁ closest to the first end 3 (in FIG. 1 shown as the left-hand edge) and the sixth lead 8₆ closest to the other (i.e. second) end 4. The region 6 connects at least two portions of channel and is herein referred to as a “shunt”. The channel 2, shunt 6 and leads 8₁, 8₂, 8₃, 8₄, 8₅, 8₆ are arranged on a base 9 formed of silicon dioxide (SiO₂) having an (unetched) thickness of 400 nm and is, in turn, arranged on a p-type silicon substrate 10.

In this example, the shunt 6 and the leads 8₁, 8₂, 8₃, 8₄, 8₅, 8₆ are connected to the sides 5, 7 of the channel 2, i.e. laterally. However, the shunt 6 and/or the leads 8₁, 8₂, 8₃, 8₄, 8₅, 8₆ can be connected to upper and/or lower surfaces of the channel, i.e. across the top or across the bottom of the channel 2.

The channel 2 is elongated and rectangular in plan view having a length, l₁, of about 17 μm and a width, w₁, of about 1 μm. The shunt 6 is also elongated and rectangular in plan view having a length, l₂, of about 17 μm and a width, w₂, of 4 μm. The leads 8₁, 8₂, 8₃, 8₄, 8₅, 8₆ each have a width, l₃, i.e. length along the channel 2, of 460 nm and are spaced apart having spacing, s, (i.e. pitch) of about 2.5 μm. In FIG. 1, longitudinal and transverse axes of the channel 2 are shown as x- and y-axes respectively and the crystal growth axis is shown as the z-axis.

The magnetoresistance device 1 exhibits the extraordinary magnetoresistance (EMR) effect and is suitable for detecting a magnetic field 11 passing (or having a component) directed along an axis passing perpendicularly to a plane in which the channel 2 and shunt 6 are connected, e.g. along the crystal growth axis (z-axis).

Referring to FIG. 2a, a first circuit configuration 12 for measuring the magnetoresistance device 1 is shown. The circuit configuration 12 includes a current source 13 configured to drive current I through the channel 2 between the first lead 8₁ and the fifth lead 8₅ and a voltmeter 14 configured to measure voltage V developed across the fourth and sixth leads 8₄, 8₆.

Referring to FIG. 2b, a graph illustrating a first theoretical current-voltage characteristic 15 for the device 1 for the first circuit configuration 12 (FIG. 2a) is shown. The device is modelled as a two-dimensional slice using finite element modelling. No fitting parameters are required in the modelling. The modelling calculates the current density and potential distribution though the device, which can be monitored using various probe configurations.

Referring to FIG. 2c, a graph illustrating a first measured current-voltage characteristic 16 of the device 1 at 300° K using the first circuit configuration 12 (FIG. 2a) is shown. A measured value of resistance can be found by dividing the measured voltage, V, by the applied current, I.

Referring to FIG. 3a, a second circuit configuration 17 for measuring the magnetoresistance device 1 is shown. The circuit configuration 17 includes a current source 18 configured to drive current, I, through the channel 2 between the first lead 8₁ and the fifth lead 8₅ and a voltmeter 19 configured to measure voltage, V, appearing across the third and sixth leads 8₃, 8₆.

Referring to FIG. 3b, a graph illustrating a second theoretical current-voltage characteristic 20 for the device 1 for the second circuit configuration 17 (FIG. 3a) is shown. The device is also modelled as a two-dimensional slice using finite element modelling.

Referring to FIG. 3c, a graph illustrating a second measured current-resistance characteristic 21 of the device 1 at 300° K using the second circuit configuration 17 (FIG. 3a) is shown. A measured value of resistance is found by dividing the measured voltage V by the applied current I.

Either circuit configuration 12 (FIG. 2a), 17 (FIG. 3a) can be used to measure a magnetic field 11 (FIG. 1). The magnitude and orientation of the applied magnetic field 11 (FIG. 1) affects the measured potential. In particular, if a more positive magnetic field 11 (FIG. 1) is applied, then a lower potential is measured. The device 1 exhibits a change in magnetoresistance of 15.3% between no applied field and an applied field of 10 T.

Referring to FIG. 4, a graph illustrating a measured resistance-magnetic field characteristic 22 of the device 1 at 300° K using the first circuit configuration 12 (FIG. 2a) is shown.

In the first and second circuit configurations 12 (FIG. 2a), 17 (FIG. 3a), current is driven and voltage is measured. However, other circuit configurations may used which have a voltage source (not shown) arranged to apply a bias between two leads and a current detector (not shown) for measuring the current flowing through the channel 2 between the leads or another two leads.

Referring to FIGS. 5a to 5d, a method of fabricating the device 1 will now be described.

Referring in particular to FIG. 5a, a silicon-on-insulator wafer is provided having a silicon layer 23, a buried silicon dioxide layer 24 and substrate 10. The silicon layer 23 has a thickness of 37 nm and is doped with phosphorous to a concentration of 6.4×10¹⁹ cm⁻³. The silicon dioxide layer 24 has a thickness of 400 nm. A naturally forming silicon dioxide layer overlying silicon layer 23 and which is usually referred to as the “surface oxide” is omitted from FIGS. 5a to 5d for clarity.

The silicon-on-insulator wafer is divided into chips and a chip is processed in the following way:

The chip is cleaned using a 3:1H₂SO₄:H₂O₂ (commonly known as a “Piranha etch”), followed by a dip in 2:5:3 NH₂F:C₂H₄O₂:H₂O (also known as a “SILOX etch”). A layer of polymethylmethacrylate (PMMA) is applied (e.g. spun-on) to an upper surface of the chip and cured by baking. The PMMA layer is patterned using a scanning electron beam and developed using a mixture of IPA and water to leave a patterned PMMA layer. The chip is given a short, for example 3-minute, oxygen plasma ash, then a 30-nm thick layer of aluminium is thermally evaporated over the PMMA-patterned surface of the chip. The developed resist is “lifted-off” in acetone, then rinsed in IPA to leave an aluminium etch mask 25. The corresponding structure of the device at this stage is shown in FIG. 5b.

Exposed areas of the silicon and silicon dioxide layers 23, 24 are etched by reactive ion etching (RIE) using a mixture of carbon tetrafluoride and silicon tetrachloride (CF₄:SiCl₄) as a feed gas. The aluminium etch mask 25 is removed using a base, such as (CH₃)₄NOH. The corresponding structure of the device at this stage is shown in FIG. 5c and shows a continuous patterned silicon layer 23′ and a partially etched silicon dioxide layer 9.

The chip is cleaned using acetone and IPA. The chip is exposed to an adhesion promoter (in vapour form), in this case hexamethyldisilizane (HMDS). Another layer of PMMA is applied to the patterned surface of the chip and cured. The PMMA layer is patterned using a scanning electron beam and developed using IPA/water to leave another patterned PMMA layer. The chip is given another short oxygen plasma ash. The surface oxide (not shown) is removed using a SILOX etch and a layer of titanium having a thickness of 40 nm is sputtered over the PMMA-patterned surface of the chip. The developed resist is lifted-off, and rinsed in IPA to leave regions 25₀, 25₁, 25₂, 25₃, 25₄, 25₅, 25₆ of titanium overlying areas of the patterned silicon layer 23′ which will form the shunt 6 and the leads 8₁, 8₂, 8₃, 8₄, 8₅, 8₆. The corresponding structure of the device at this stage is shown in FIG. 5d. In some embodiments, the patterned silicon layer 23′ is doped before depositing the layer of titanium. For example, an n-type impurity, such as phosphorous, may be ion implanted (using the resist as a mask) into the surface of the patterned silicon layer 23′ to provide a doping density of 1×10²⁰ cm⁻³ or 1×10²¹ cm⁻³ under the titanium layer.

The chip is annealed at 700° C. in an inert atmosphere, such as dry nitrogen. Unreacted titanium is removed using a Piranha etch. The corresponding structure of the device at this stage is shown in FIG. 1. FIG. 6a is an optical micrograph of the device at this stage. FIG. 6b is an electron micrograph of part of the channel 2.

The chip is cleaned using acetone and IPA. A layer of optical resist is spun-on. The optical resist layer is patterned using a mask (which is also referred to as a reticle) and a UV light source and developed using an optical resist developer to leave a patterned optical resist layer. The chip is given a short, for example 30 s, oxygen plasma ash, then successive layers of chromium and gold are thermally evaporated over the resist-patterned surface of the chip. The resist is lifted-off in acetone, then rinsed in IPA to leave gold bond pads (not shown). FIG. 6c is an optical micrograph of the device 1.

Referring to FIGS. 7a and 7b, a second magnetoresistance device 26 according to certain embodiments of the present invention is shown. The device 26 includes a channel 27 formed of n-type polycrystalline Si doped with P to a concentration of 1×10¹⁷ cm⁻³ and having a thickness of about 40 nm. The channel 27 extends between first and second ends 28, 29 and has connected thereto, along a first side 30, a shunt 31 formed of n-type polycrystalline Si, doped with P to a concentration of 1×10²¹ cm⁻³ and having a thickness of about 40 nm and, on a second, opposite side 32, first, second, third and fourth leads 33₁, 33₂, 33₃, 33₄ also formed of n-type polycrystalline Si doped with P to a concentration of 1×10²¹ cm⁻³ and spaced apart along the channel 27. The first, second, third, fourth leads 33₁, 33₂, 33₃, 33₄ are arranged in order along the channel 27.

Different doping concentrations in the channel 27, shunt 31 and leads 33₁, 33₂, 33₃, 33₄ can be achieved by depositing a diffusion barrier layer (not shown), e.g. silicon nitride, over a patterned layer of undoped silicon, opening windows (not shown) in the diffusion barrier layer over regions corresponding to the shunt and leads, then ion-implanting or gaseously diffusing dopant, such as phosphorous, through the windows and into the regions corresponding to the shunt and leads. The diffusion barrier layer is removed by wet etching and the sample annealed.

Alternatively, different doping concentrations in the channel 27, shunt 31 and leads 33₁, 33₂, 33₃, 33₄ can be achieved by scanning ion beam implantation and annealing. The channel 27, shunt 31 and leads 33₁, 33₂, 33₃, 33₄ are arranged on an insulating base 34 formed of SiO₂ having a thickness of 10 nm and is, in turn, arranged on a p-type silicon substrate 35. The base 34 includes windows 36₁, 36₂, 36₃, 36₄, which are used during fabrication to define first, second, third and fourth regions 37₁, 37₂, 37₃, 37₄ of n-type silicon (often referred to as “diffusion wells” or simply “wells”) in the p-type silicon substrate 35.

The channel 27 has a length, l₁, of about 1 μm and a width, w₁, of about 50 nm. The shunt 31 has a length, l₂, of about 1 μm and a width, w₂, of about 0.2 μm. The leads 33₁, 33₂, 33₃, 33₄ each have a width, v₁, of 200 nm. The first and second leads 33₁, 33₂, are spaced apart by a first separation (i.e. pitch), s₁, of 0.75 μm. The windows 36₁, 36₂, 36₃, 36₄ each have a width, v₂, of about 200 nm. The others leads 33₂, 33₃, 33₄ are spaced apart from neighbouring leads by a second separation, s₂, of 0.1 μm. In some embodiments of the invention, the second separation s₂ is made as small as possible and may correspond to the minimum feature size, F.

The first and second n-type wells 37₁, 37₂ provide source and drain regions for a first channel 38₁ running between the wells 37₁, 37₂. The second lead 33₂ overlies and is separated from the first channel 38₁ by a first portion 34₁ of the insulating base 34, thereby providing a gate electrode and a gate oxide respectively for a first metal-oxide-semiconductor field-effect transistor (MOSFET) 39₁. Likewise, the third and fourth n-type wells 37₃, 37₄, a second channel 38₂, a second gate oxide 34₂ and the fourth lead 33₄ provide a second MOSFET 39₂.

During operation, a current, I, is driven through the channel 27 between the first and third leads 33₁, 33₃. Biases are applied between source and drain regions 37₁, 37₂, 37₃, 37₄, of each MOSFETs 39₁, 39₂ and the respective source-drain currents, I_{SD}, measured so as to determine potentials of the second and fourth leads 33₂, 33₄.

Referring to FIG. 8, the device 1, 26 is useable as a read head in a hard disk drive 40. A slider 41 supports the device 1, 26 (inverted with respect to the configuration shown in FIG. 1a or 7b) and a write head 42 over a rotatable platen 43. The device 1, 26 measures magnetic field 44 produced by a perpendicularly-arranged bit cell 45 passing beneath it. The device 1, 26 may be used in a hard disk drive having longitudinally-arranged bit cells.

Referring to FIG. 9, a third magnetoresistance device 1′ according to certain embodiments of the present invention is shown. The device 1′ is a modification of the device 1 shown in FIG. 1.

An interface 46 between the shunt 6′ and channel 2′ may be broken into at least two, separate sections 46₁, 46₂ by at least one region 47 without conducting material or of non-conductive material. For example, the (or each) region 47 may be a void cut using ion milling or a region of damaged material formed by ion implantation. This can enhance the magnetoresistance.

In this example, the region 47 has a length L such that the shunt 6′ contacts the channel 2′ at least at the same point (i.e. length) along channel 2′ at which the outermost leads 8₁, 8₆ are connected to the channel 2′. Additional regions 48 of non-conductive material may be provided to limit further the length of contact along the channel 2′ so that the shunt 6′ contacts the channel 2′ only at the same points along channel 2′ at which the outermost leads 8₁, 8₆ are connected to the channel 2′. Alternatively, the shunt 6′ may contact two points proximate to distal ends of the channel 2′.

The device 26 (FIGS. 7a and 7b) can be modified in a similar way.

It will be appreciated that many modifications may be made to the embodiments hereinbefore described. The channel need not be straight, but may be curved in-plane. The device may be a silicon-based device, for example the channel, shunt and/or the leads may comprise a silicon-containing material, such as silicon or silicon-germanium (e.g. Si_{0.9}Ge_{0.1}). Different silicon-containing materials can be used in different parts of the device. The channel may comprise silicon germanium. The channel may be undoped or doped with an impurity (n-type or p-type) up to a concentration of 1×10¹⁷ cm⁻³, up to a concentration of 1×10¹⁸ cm⁻³, up to a concentration of 1×10¹⁹ cm⁻³ or up to a concentration of 1×10²⁰ cm⁻³. The channel may be provided in a layer having a different thickness to those described earlier, for example having a thickness less than 50 nm, preferably between 5 and 40 nm. The shunt can be arranged above and/or below the channel, i.e. underlie and/or overlie the channel, and contact top and/or bottom sides of the channel. Re-arranging the configuration of shunt relative to the channel may change the axis along which the device senses a magnetic field. The shunt may extend along a portion of the channel, i.e. less than the full length of the channel. The shunt may be polygonal in plan view. The shunt may include more than one discrete part, e.g. in the form a broken line of conducting regions along the channel. The shunt may comprise semiconducting material having a higher conductivity than the semiconducting material comprising the channel. The semiconducting material comprising the shunt may be doped with an impurity having a concentration of at least 1×10¹⁹ cm⁻³, for example 1×10²¹ cm⁻³, and may comprise one or more δ-doped layers. The shunt may comprise a metal silicide and need not be titanium silicide. As explained earlier, n-type (or p-type) impurity may be implanted or diffused into the surface of the patterned silicon layer before depositing the metal for the metal silicide. The shunt may comprise a non-ferromagnetic material, such as a non-ferromagnetic metal or alloy, such as aluminium. The shunt may be provided in a layer having a different thickness, for example less than 50 nm. The leads may comprise a semiconducting material and may be doped with an impurity (n-type or p-type) up to a concentration of different, e.g. higher, than the semiconducting material in the channel. The leads need not be formed of titanium silicide, but may comprise a metal silicide. The leads may comprise a non-ferromagnetic metal or alloy. The leads may each have a thickness less than 50 nm. The channel may have a width (i.e. w₁) less than 100 nm and/or a length (i.e. l₁) less than 10 μm. The shunt may have a width (i.e. w₂) up to 500 nm and/or a length (i.e. l₂) less than 10 μm which may or may not be the same as the length of the channel. The leads may each have a width (i.e. l₃) up to 200 nm, the width being in a direction which corresponds to length for the channel. The leads need not be arranged perpendicularly with respect to the channel. End leads, for example first and sixth leads 8₁, 8₆ (FIG. 1), may be arranged to approach the channel, e.g. channel 2 (FIG. 1), from the ends, e.g. ends 3, 4 (FIG. 1) of the channel, rather than transversely. At least some of the leads can be arranged above and/or below the channel, i.e. underlie and/or overlie the channel. The shunt and the leads need not be arranged on opposite sides (or surfaces) of the channel. Other concentrations and mixtures for etches and developers may be used. Other etches, resists and developers may be used. Etching, exposure and development time can be varied and can be found by routine experiment. The anneal temperature may also be found by routine experiment.

1. A magnetoresistance device comprising a channel comprising non-ferromagnetic semiconducting material, the channel extending from a first end to a second end, a conductor comprising non-ferromagnetic material having a higher conductivity than the semiconducting material and connecting at least two sections of the channel and a plurality of leads connected to and spaced apart along the channel.

2. A device according to claim 1, wherein the channel is an elongate channel.

3. A device according to claim 1, wherein the channel is curved.

4. A device according to claim 1, wherein the channel comprises silicon.

5. A device according to claim 1, wherein the channel comprises silicon germanium.

6. A device according to claim 1, wherein the conductor is connected to the channel along a first side of the channel.

7. A device according to claim 6, wherein at least some of the leads are connected to the channel on a second, opposite side of the channel.

8. A device according to claim 6, wherein at least some of the leads are connected to the channel on an upper or lower surface of the channel.

9. A device according to claim 1, comprising first, second, third and fourth leads arranged in order along channel.

10. A device according to claim 9, wherein the first and second leads are spaced apart by a first separation, the second and third leads are spaced apart by a second separation less than the first separation and the third and fourth leads are spaced apart by third separation less than the first separation.

11. A device according to claim 1, further comprising a cap comprising insulating material, wherein the cap lies over the channel, region and leads.

12. A device according to claim 1, further comprising circuitry for controlling the device.

13. A device according to claim 12, wherein the circuitry is configured to drive current between non-adjacent leads and to measure a voltage developed between a lead between the non-adjacent leads and another lead.

14. A method of fabricating a magnetoresistance device, the method comprising:
forming a channel comprising non-ferromagnetic semiconducting material, the channel extending from a first end to a second end;
connecting at least two sections of the channel using a conductor comprising non-ferromagnetic material; and
connecting to the channel, a plurality of leads spaced apart along the channel.

15. A method according to claim 14, wherein the semiconducting material is silicon and the method comprises:
providing a layer of silicon;
patterning said layer so as to define a patterned layer having a first region corresponding to the conductor, a second region corresponding to the channel and further regions corresponding to the leads;
providing a metal over the first region; and
annealing so as to form a metal silicide in said first region.

16. A method of operating a magnetoresistance device comprising a channel comprising non-ferromagnetic semiconducting material, the channel extending from a first end to a second end, a conductor comprising non-ferromagnetic material having a higher conductivity than the semiconducting material and connecting at least two regions of the channel and a plurality of leads spaced apart along the channel, the method comprising:
driving current between non-adjacent leads; and
measuring a voltage developed between a lead which is between the non-adjacent leads and another lead.

17. A method according to claim 16, wherein driving the current between non-adjacent leads comprises driving a current having a magnitude of at least 1 μA.

18. A method according to claim 16, further comprising:
applying a magnetic field to the magnetoresistance device.
